(19) United States
(12) Patent Application Publication
(10) Pub. No.: US 2015/0379848 A1
(43) Pub. Date: Dec. 31, 2015

(54) ALERT SYSTEM FOR SENSOR BASED DETECTION SYSTEM

(71) Applicants: Allied Telesis Holdings Kabushiki Kaisha, Tokyo (JP); ALLIED TELESIS, INC., Bothell, WA (US)

(72) Inventors: Joseph L. Gallo, Santa Cruz, CA (US); Ferdinand E. K. de Antoni, Manila (PH); Scott Gill, Taguig (PH); Daniel Stellick, Geneva, IL (US)

(73) Assignee: ALLIED TELESIS, INC., Bothell, WA (US)

(21) Appl. No.: 14/604,472

(22) Filed: Jan. 23, 2015

Related U.S. Application Data
(63) Continuation-in-part of application No. 14/315,289, filed on Jun. 25, 2014.

(51) Int. Cl. G08B 21/02

(52) U.S. Cl. CPC G08B 21/02

(57) ABSTRACT

Some embodiments provide a system that includes an alert module, an event module, a notification trigger module, and a notification alert module. The alert module may be configured to receive a plurality of different sensor modality alerts. The event module may be configured to determine events based on the plurality of different sensor modality alerts. The notification trigger module may be configured to determine whether to cause transmission of notification alerts based on the determined events. The notification alert module may be configured to communicate notification alerts to a plurality of third parties based on the determination by the notification trigger module.

### RELATED APPLICATIONS

The present application is a continuation in part of U.S. patent application Ser. No. 14/315,289, filed on Jun. 25, 2014, by Gallo et al., which is incorporated herein in its entirety and for all purposes.

This application is related to U.S. patent application Ser. No. 14/281,896, titled “Sensor Based Detection System,” by Joseph L. Gallo et al. (Attorney Docket No. 13-012-00-US), filed May 20, 2014, which application is incorporated herein by reference in its entirety and claims the benefit and priority thereto.

This application is related to U.S. patent application Ser. No. 14/281,901, titled “Sensor Based Detection Management Platform,” by Joseph L. Gallo et al. (Attorney Docket No. 13-013-00-US), filed May 20, 2014, which application is incorporated herein by reference in its entirety and claims the benefit and priority thereto.

This application is related to U.S. patent application Ser. No. 14/315,286, titled “Method and System for Representing Sensor Associated Data,” by Joseph L. Gallo et al. (Attorney Docket No. 13-014-00-US), filed Jun. 25, 2014, which application is incorporated herein by reference in its entirety and claims the benefit and priority thereto.

This application is related to U.S. patent application Ser. No. 14/315,289, titled “Method and System for Sensor Associated Messaging,” by Joseph L. Gallo et al. (Attorney Docket No. 13-015-00-US), filed Jun. 25, 2014, which application is incorporated herein by reference in its entirety and claims the benefit and priority thereto.

This application is related to U.S. patent application Ser. No. 14/315,317, titled “Path Determination of a Sensor Based Detection System,” by Joseph L. Gallo et al. (Attorney Docket No. 13-016-00-US), filed Jun. 25, 2014, which application is incorporated herein by reference in its entirety and claims the benefit and priority thereto.

This application is related to U.S. patent application Ser. No. 14/315,320, titled “Graphical User Interface of a Sensor Based Detection System,” by Joseph L. Gallo et al. (Attorney Docket No. 13-017-00-US), filed Jun. 25, 2014, which application is incorporated herein by reference in its entirety and claims the benefit and priority thereto.

This application is related to U.S. patent application Ser. No. 14/315,322, titled “Graphical User Interface for Path Determination of a Sensor Based Detection System,” by Joseph L. Gallo et al. (Attorney Docket No. 13-018-00-US), filed Jun. 25, 2014, which application is incorporated herein by reference in its entirety and claims the benefit and priority thereto.

This application is related to U.S. patent application Ser. No. 14/281,904, titled “Event Management System for a Sensor Based Detection System,” by Joseph L. Gallo et al. (Attorney Docket No. 13-020-00-US), filed May 20, 2014, which application is incorporated herein by reference in its entirety and claims the benefit and priority thereto.

This application is related to U.S. patent application Ser. No. 14/284,009, titled “User Query and Gauge-Reading Relationships,” by Joseph L. Gallo et al. (Attorney Docket No. 13-027-00-US), filed May 21, 2014, which application is incorporated herein by reference in its entirety and claims the benefit and priority thereto.

This application is related to Philippines Patent Application No. 1/2013/000136, titled “A Domain Agnostic Method and System for the Capture, Storage, and Analysis of Sensor Readings,” by Joseph L. Gallo et al. (Attorney Docket No. 13-027-00-PH), filed May 23, 2013, which application is incorporated herein by reference in its entirety and claims the benefit and priority thereto.

This application is related to U.S. patent application Ser. No. 14/336,994 titled “Sensor Grouping for a Sensor Based Detection System”, by Joseph L. Gallo et al. (Attorney Docket No. 13-021-00-US) and filed Jul. 21, 2014, which application is incorporated herein by reference in its entirety and claims the benefit and priority thereto.

This application is related to U.S. patent application Ser. No. 14/337,012, titled “Data Structure for a Sensor Based Detection System”, by Joseph L. Gallo et al. (Attorney Docket No. 13-022-00-US) and filed Jul. 21, 2014, which application is incorporated herein by reference in its entirety and claims the benefit and priority thereto.

This application is related to U.S. patent application Ser. No. 14/488,229, titled “Sensor Associated Data Processing Customization”, by Joseph L. Gallo et al. (Attorney Docket No. 13-023-00-US) and filed Sep. 16, 2014, which application is incorporated herein by reference in its entirety and claims the benefit and priority thereto.

### BACKGROUND

As technology has advanced, computing technology has proliferated to an increasing number of areas while decreasing in price. Consequently, devices such as smartphones, laptops, GPS, etc., have become prevalent in our community, thereby increasing the amount of data being gathered in an ever increasing number of locations. Unfortunately, most of the information gathered is used for marketing and advertising to the end user, e.g., a smartphone user receives a coupon to a nearby coffee shop, etc., while the security of our community is left exposed and at a risk of terrorist attacks such as the Boston Marathon bombers.

### SUMMARY

Accordingly, a need has arisen for a solution to allow monitoring and collection of data from a plurality of sensors and management of the plurality of sensors for improving the security of our communities, e.g., by detecting radiation, etc. Further, there is a need to provide relevant information based on the sensors in an efficient manner to increase security

In some embodiments, a system includes an alert module, an event module, a notification trigger module, and a notification alert module. The alert module may be configured to receive a plurality of different sensor modality alerts. The event module may be configured to determine events based on the plurality of different sensor modality alerts. The notification trigger module may be configured to determine whether to cause transmission of notification alerts based on the determined events. The notification alert module may be configured to communicate notification alerts to a plurality of third parties based on the determination by the notification trigger module.

In some embodiments, the system further includes a messaging module that is configured to receive the notification alerts from the notification alert module. The messaging module may be further configured to send messages to the plurality of third parties via a plurality of different communication platforms based on the notification alerts. The notification trigger module may be further configured to determine whether to cause transmission of notification alerts further based on at least one alert in the plurality of different sensor modality alerts. In some embodiments, the notification trigger module determines whether to cause transmission of notification alerts by determining whether conditions specified for the notification trigger are satisfied. The notification alert module may be further configured to communicate notification alerts for the notification trigger when the notification trigger module determines that the conditions specified for the notification trigger are satisfied.

In some embodiments, the system further includes a data store module configured to receive data associated with a sensor having a plurality of different sensing modalities. The data store module may be further configured to determine whether a state of a sensing modality in the plurality of different sensing modalities of the sensor has changed and to generate a sensor modality alert based on the state change of the sensing modality.

In some embodiments, a system includes a sensor with a plurality of modalities and a notification module. The sensor may be configured to measure information associated with a plurality of data types. Each data type may be associated with a modality of the plurality of modalities. The sensor may be further configured to generate a plurality of modality measurements. The notification module may be configured to process the plurality of modality measurements and to determine whether a set of conditions are satisfied. The notification module may be further configured to perform a set of actions in response to determining that the conditions are satisfied.

The set of actions may include sending a message to a set of third parties regarding the plurality of modality measurements. The notification module may be further configured to determine an event based on the plurality of modality measurements. The set of conditions may be based on the determined event. In some embodiments, the system may further include a data store configured to receive the plurality of modality measurements. The data store may be further configured to generate a plurality of sensor alerts based on the plurality of modality measurements. It is appreciated that the plurality of modalities includes a radiation modality.

In some embodiments, a system includes a sensor and a set of computing devices. The sensor may be configured to measure information associated with a first data type and a second data type. The first data type may be associated with a first modality and the second data type may be associated with a second modality. The sensor may be further configured to generate a plurality of modality measurements. The set of computing devices may be configured to process the plurality of measurements and to determine whether a set of conditions are satisfied. The set of computing devices may be further configured to send messages to a plurality of third parties in response to determining that the set of conditions are satisfied.

In some embodiments, the sensor is further configured to measure information associated with a third data type. The third data type may be associated with a third modality. The system may further include a data store configured to receive the plurality of modality measurements. In some embodiments, the set of computing devices is further configured to provide a graphical user interface for specifying the set of conditions. It is appreciated that the set of conditions are specified through the graphical user interface based on a template.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows an operating environment of a sensor based detection system in accordance with some embodiments.

FIG. 2 shows a data flow diagram in accordance with some embodiments.

FIG. 3 shows a block diagram of exemplary messaging dataflow in accordance with some embodiments.

FIGS. 4A-4D show a graphical user interface for creating notification triggers in accordance with some embodiments.

FIG. 5 shows a flow diagram for processing a notification trigger in accordance with some embodiments.

FIG. 6 shows a block diagram of a computer system in accordance with some embodiments.

FIG. 7 shows a block diagram of another computer system in accordance with some embodiments.

### DETAILED DESCRIPTION

Reference will now be made in detail to various embodiments, examples of which are illustrated in the accompanying drawings. While various embodiments are described herein, it will be understood that these various embodiments are not intended to limit the scope of the embodiments. On the contrary, the embodiments are intended to cover alternatives, modifications, and equivalents, which may be included within the scope of the embodiments as construed according to the appended Claims. Furthermore, in the following detailed description of various embodiments, numerous specific details are set forth in order to provide a thorough understanding of the concept. However, it will be evident to one of ordinary skill in the art that the concept may be practiced without these specific details. In other instances, well known methods, procedures, components, and circuits have not been described in detail as not to unnecessarily obscure aspects of the concept and embodiments.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in an electronic device, a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “creating,” “generating,” “storing,” “retrieving,” “determining,” “sending,” “receiving,” “transmitting,” “communicating,” “providing,” “accessing,” “associating,” “configuring,” “processing,” “forwarding,” “performing,” “formatting,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of machine-executable instructions residing on some form of machine-readable storage medium, such as program modules, executed by one or more computers, computing devices, or other devices. By way of example, and not limitation, machine-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as machine-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of machine-readable storage media.

Accordingly, a need has arisen for a solution to allow monitoring and collection of data from a plurality of sensors and management of the plurality of sensors for improving the security of our communities, e.g., by detecting radiation, etc. Further, there is a need to provide relevant information based on the sensors in an efficient manner to increase security.

Embodiments described herein are directed to notification alert systems that communicate alerts to third parties based on different sensor modality alerts. In some embodiments, the notification alert system allows users to create notification triggers that specify actions to be performed when conditions specified for the notification triggers are satisfied. The conditions may be based on any number of different sensor modality alerts and/or events. The actions may include sending messages (e.g., notification alerts) to any number of different third parties.

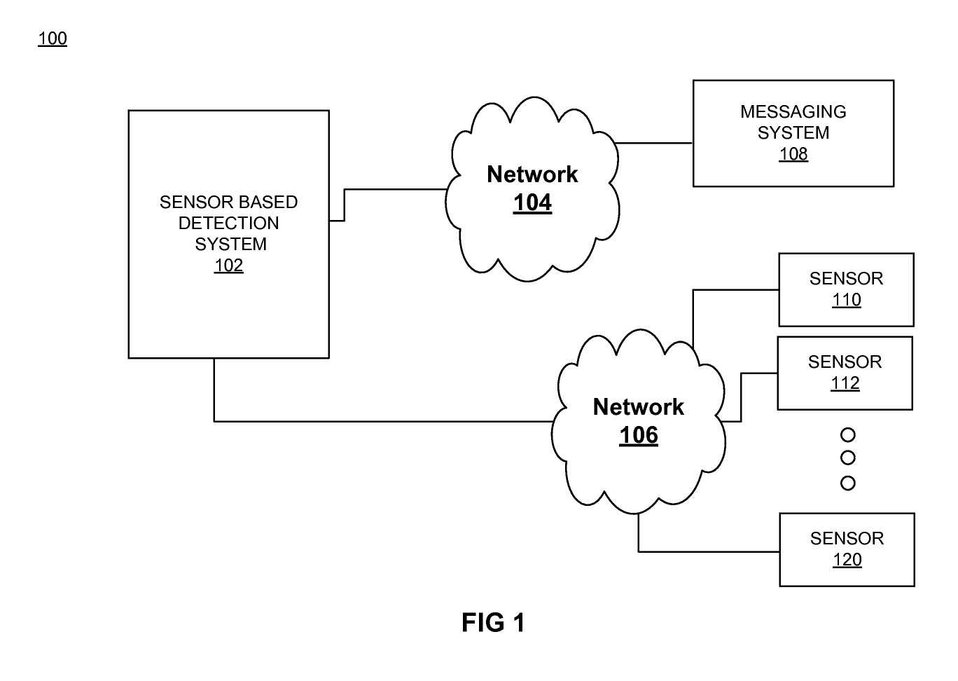

FIG. 1 shows an operating environment in accordance with some embodiments. The operating environment 100 includes a sensor based detection system 102, a network 104, a network 106, a messaging system 108, and sensors 110-120. The sensor based detection system 102 and the messaging system 108 are coupled to a network 104. The sensor based detection system 102 and messaging system 108 are communicatively coupled via the network 104. The sensor based detection system 102 and sensors 110-120 are coupled to a network 106. The sensor based detection system 102 and sensors 110-120 are communicatively coupled via network 106. The networks 104, 106 may include more than one network (e.g., intranets, the Internet, local area networks (LAN)s, wide area networks (WAN)s, etc.) and may be a combination of one or more networks including the Internet. In some embodiments, network 104 and network 106 may be a single network.

The sensors 110-120 detect a reading associated therewith, e.g., gamma radiation, vibration, etc., and transmit that information to the sensor based detection system 102 for analysis. The sensor based detection system 102 may use the received information and compare it to a threshold value, e.g., historical values, user selected values, etc., in order to determine whether a potentially hazardous event has occurred. In response to the determination, the sensor based detection system 102 may transmit that information to the messaging system 108 for appropriate action, e.g., emailing the appropriate personnel, sounding an alarm, tweeting an alert, alerting the police department, alerting homeland security department, etc. Accordingly, appropriate actions may be taken in order to avert the risk.

The sensors 110-120 may be any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), complementary metal-oxide-semiconductor (CMOS), biological/chemical (e.g., toxins, nutrients, etc.), etc. The sensors 110-120 may further be any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal based portal sensors, biochemical, pressure, air quality, water quality, fire, flood, intrusion detection, motion detection, particle count, water level, surveillance cameras, etc. The sensors 110-120 may be video cameras (e.g., internet protocol (IP) video cameras) or purpose built sensors.

The sensors 110-120 may be fixed in location (e.g., surveillance cameras or sensors), semi-fixed (e.g., sensors on a cell tower on wheels or affixed to another semi portable object), or mobile (e.g., part of a mobile device, smartphone, etc.). The sensors 110-120 may provide data to the sensor based detection system 102 according to the type of the sensors 110-120. For example, sensors 110-120 may be CMOS sensors configured for gamma radiation detection. Gamma radiation may thus illuminate a pixel, which is converted into an electrical signal and sent to the sensor based detection system 102.

The sensor based detection system 102 is configured to receive data and manage sensors 110-120. The sensor based detection system 102 is configured to assist users in monitoring and tracking sensor readings or levels at one or more locations. The sensor based detection system 102 may have various components that allow for easy deployment of new sensors within a location (e.g., by an administrator) and allow for monitoring of the sensors to detect events based on user preferences, heuristics, etc. The events may be used by the messaging system 108 to generate sensor-based alerts (e.g., based on sensor readings above a threshold for one sensor, based on the sensor readings of two sensors within a certain proximity being above a threshold, etc.) in order for the appropriate personnel to take action. The sensor based detection system 102 may receive data and manage any number of sensors, which may be located at geographically disparate locations. In some embodiments, the sensors 110-120 and components of a sensor based detection system 102 may be distributed over multiple systems (e.g., and virtualized) and a large geographical area.

The sensor based detection system 102 may track and store location information (e.g., board room B, floor 2, terminal A, etc.) and global positioning system (GPS) coordinates, e.g., latitude, longitude, etc. for each sensor or group of sensors. The sensor based detection system 102 may be configured to monitor sensors and track sensor values to determine whether a defined event has occurred, e.g., whether a detected radiation level is above a certain threshold, etc., and if so then the sensor based detection system 102 may determine a route or path of travel that dangerous or contraband material is taking around or within range of the sensors. For example, the path of travel of radioactive material relative to fixed sensors may be determined and displayed via a graphical user interface. It is appreciated that the path of travel of radioactive material relative to mobile sensors, e.g., smartphones, etc., or relative to a mixture of fixed and mobile sensors may similarly be determined and displayed via a graphical user interface. It is appreciated that the analysis and/or the sensed values may be displayed in real-time or stored for later retrieval.

The sensor based detection system 102 may display a graphical user interface (GUI) for monitoring and managing sensors 110-120. The GUI may be configured for indicating sensor readings, sensor status, sensor locations on a map, etc. The sensor based detection system 102 may allow review of past sensor readings and movement of sensor detected material or conditions based on stop, play, pause, fast forward, and rewind functionality of stored sensor values. The sensor based detection system 102 may also allow viewing of an image or video footage (e.g., motion or still images) corresponding to sensors that had sensor readings above a threshold (e.g., based on a predetermined value or based on ambient sensor readings). For example, a sensor may be selected in a GUI and video footage associated with an area within the sensor's range of detection may be displayed, thereby enabling a user to see an individual or person transporting hazardous material. According to some embodiments the footage is displayed in response to a user selection or it may be displayed automatically in response to a certain event, e.g., sensor reading associated with a particular sensor or group of sensors being above a certain threshold.

In some embodiments, sensor readings of one or more sensors may be displayed on a graph or chart for easy viewing. A visual map-based display depicting sensors may be displayed with the sensors representations and/or indicators, which may include color coding, shapes, icons, flash rate, etc., according to the sensors' readings and certain events. For example, gray may be associated with a calibrating sensor, green may be associated with a normal reading from the sensor, yellow may be associated with an elevated sensor reading, orange associated with a potential hazard sensor reading, and red associated with a hazard alert sensor reading.

The sensor based detection system 102 may determine alerts or sensor readings above a specified threshold (e.g., predetermined, dynamic, or ambient based) or based on heuristics and display the alerts in the graphical user interface (GUI). The sensor based detection system 102 may allow a user (e.g., operator) to group multiple sensors together to create an event associated with multiple alerts from multiple sensors. For example, a code red event may be created when three sensors or more within twenty feet of one another and within the same physical space have a sensor reading that is at least 40% above the historical values. In some embodiments, the sensor based detection system 102 may automatically group sensors together based on geographical proximity of the sensors, e.g., sensors of gates 1, 2, and 3 within terminal A at LAX airport may be grouped together due to their proximate location with respect to one another, e.g., physical proximity within the same physical space, whereas sensors in different terminals may not be grouped because of their disparate locations. However, in certain circumstances sensors within the same airport may be grouped together in order to monitor events at the airport and not at a more granular level of terminals, gates, etc.

The sensor based detection system 102 may send information to a messaging system 108 based on the determination of an event created from the information collected from the sensors 110-120. The messaging system 108 may include one or more messaging systems or platforms which may include a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc. For example, national information exchange model (NIEM) compliant messaging may be used to report chemical, biological, radiological and nuclear defense (CBRN) suspicious activity reports (SARs) to report to government entities (e.g., local, state, or federal government).

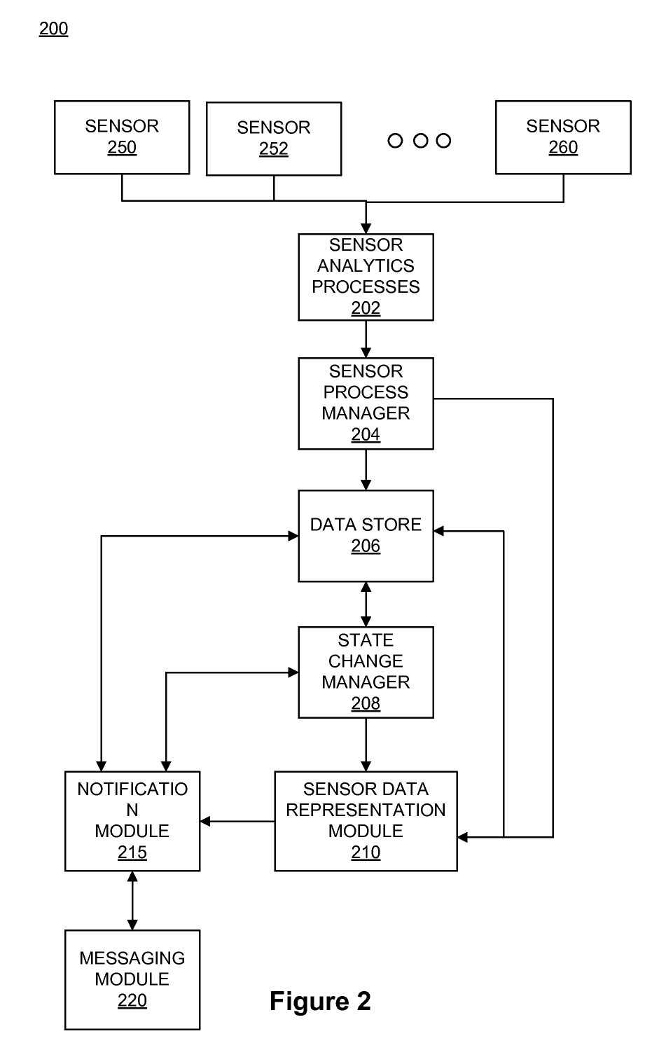

FIG. 2 shows a data flow diagram in accordance with some embodiments. Diagram 200 depicts the flow of data (e.g., sensor readings, raw sensor data, analyzed sensor data, etc.) associated with a sensor based detection system (e.g., sensor based detection system 102). Diagram 200 includes sensors 250-260, sensor analytics processes 202, a sensor process manager 204, a data store 206, a state change manager 208, a sensor data representation module 210, notification module 215, and messaging module 220. In some embodiments, the sensor analytics processes 202, the sensor process manager 204, the state change manager 208, the sensor data representation module 210, notification module 215, and messaging module 220 may execute on one or more computing systems (e.g., virtual or physical computing systems). The data store 206 may be part of or stored in a data warehouse.

The sensors 250-260 may be substantially similar to sensors 110-120 and may be any of a variety of sensors as described above. The sensors 250-260 may provide data (e.g., as camera stream data, video stream data, etc.) to the sensor analytics processes 202.

The sensor process manager 204 is configured to initiate or launch sensor analytics processes 202. The sensor process manager 204 is configured to configure each instance or process of the sensor analytics processes 202 based on configuration parameters (e.g., preset, configured by a user, etc.). In some embodiments, the sensor analytics processes 202 may be configured by the sensor process manager 204 to organize sensor readings over particular time intervals (e.g., 30 seconds, one minute, one hour, one day, one week, one year). It is appreciated that the particular time intervals may be preset or it may be user configurable. It is further appreciated that the particular time intervals may be changed dynamically, e.g., during run time, or statically. In some embodiments, a process of the sensor analytics processes 202 may be executed for each time interval. The sensor process manager 204 may also be configured to access or receive metadata associated with sensors 250-260 (e.g., geospatial coordinates, network settings, user entered information, etc.).

The sensor process manager 204 receives analyzed sensor data from sensor analytics processes 202. The sensor process manager 204 may then send the analyzed sensor data to the data store 206 for storage. The sensor process manager 204 may further send metadata associated with sensors 250-260 for storage in the data store 206 with the associated analyzed sensor data. In some embodiments, the sensor process manager 204 may send the analyzed sensor data and metadata to the sensor data representation module 210. In some embodiments, the sensor process manager 204 sends the analyzed sensor data and metadata associated with sensors 250-260 to the sensor data representation module 210. It is appreciated that the information transmitted to the sensor data representation module 210 from the sensor process manager 204 may be in a message based format.

In some embodiments, the sensor analytics processes 202 may then send the analyzed sensor data to the data store 206 for storage. The sensor analytics processes 202 may further send metadata associated with sensors 250-260 for storage in the data store 206 with the associated analyzed sensor data.

The state change manager 208 may access or receive analyzed sensor data and associated metadata from the data store 206. The state change manager 208 may be configured to analyze sensor readings for a possible change in the state of the sensor. It is appreciated that in some embodiments, the state change manager 208 may receive the analyzed sensor data and/or associated metadata from the sensor analytics processes 202 directly without having to fetch that information from the data store 206 (not shown).

The state change manager 208 may determine whether a state of a sensor has changed based on current sensor data and previous sensor data. Changes in sensors state based on the sensor readings exceeding a threshold, within or outside of a range, etc., may be sent to a sensor data representation module 210 (e.g., on a per sensor basis, on a per group of sensors basis, etc.). For example, a state change of the sensor 252 may be determined based on the sensor 252 changing from a prior normal reading to an elevated reading (e.g., above a certain threshold, within an elevated reading, within a dangerous reading, etc.) In another example, the state of sensor 250 may be determine not to have changed based on the sensor 252 having an elevated reading within the same range as the prior sensor reading. In some embodiments, the various states of sensors and associated alerts may be configured by a sensor process manager 204. For example, the sensor process manager 204 may be used to configure thresholds, ranges, etc., that may be compared against sensor readings to determine whether an alert should be generated. For example, the sensors 205-260 may have five possible states: calibrating, nominal, elevated, potential, warning, and danger. It is appreciated that the configuring of the sensor process manager 204 may be in response to a user input. For example, a user may set the threshold values, ranges, etc., and conditions to be met for generating an alert. In some embodiments, color may be associated with each state. For example, dark gray may be associated with a calibration state, green associated with a nominal state, yellow associated with an elevated state, orange associated with a potential state, and red associated with an alert state. Light gray may be used to represent a sensor that is offline or not functioning.

In some embodiments, the state change manager 208 is configured to generate an alert or alert signal if there is a change in the state of a sensor to a new state. For example, an alert may be generated for a sensor that goes from a nominal state to an elevated state or a potential state. In some embodiments, the state change manager 208 includes an active state table. The active state table may be used to store the current state and/or previous and thereby the active state table is maintained to determine state changes of the sensors. The state change manager 208 may thus provide real-time sensing information based on sensor state changes.

In some embodiments, the state change manager 208 may determine whether sensor readings exceed normal sensor readings from ambient sources or whether there has been a change in the state of the sensor and generate an alert. For example, with gamma radiation, the state change manager 208 may determine if gamma radiation sensor readings are from a natural source (e.g., the sun, another celestial source, etc.) or other natural ambient source based on a nominal sensor state, or from radioactive material that is being transported within range of a sensor based on an elevated, potential, warning, or danger sensor state. In one exemplary embodiment, it is determined whether the gamma radiation reading is inside a safe range based on a sensor state of nominal or outside of the safe range based on the sensor state of elevated, potential, warning, or danger.

In some embodiments, individual alerts may be sent to an external system (e.g., a messaging system 108). For example, one or more alerts that occur in a certain building within time spans of one minute, two minutes, or 10 minutes may be sent to a messaging system. It is appreciated that the time spans that the alerts are transmitted may be preset or selected by the system operator. In some embodiments, the time spans that the alerts are transmitted may be set dynamically, e.g., in real time, or statically.

The sensor data representation module 210 may access or receive analyzed sensor data and associated metadata from the sensor process manager 204 or data store 206. The sensor data representation module 210 may further receive alerts (e.g., on a per sensor basis, on per location basis, etc.) based on sensor state changes determined by the state change manager 208.

The sensor data representation module 210 may be configured to render a graphical user interface depicting sensors, sensor state, alerts, sensor readings, etc. The sensor data representation module 210 may display one or more alerts, which occur when a sensor reading satisfies a certain condition visually on a map, e.g., when a sensor reading exceeds a threshold, falls within a certain range, is below a certain threshold, etc. The sensor data representation module 210 may thus notify a user (e.g., operator, administrator, etc.) visually, audibly, etc., that a certain condition has been met by the sensors, e.g., possible bio-hazardous material has been detected, elevated gamma radiation has been detected, etc. The user may have the opportunity to inspect the various data that the sensor analytics processes 202 have generated (e.g. mSv values, bio-hazard reading level values, etc.) and generate an appropriate event case file including the original sensor analytics process 202 data (e.g. raw stream data, converted stream data, preprocessed sensor data, etc.) that triggered the alert. The sensor data representation module 210 may be used (e.g., by operators, administrators, etc.) to gain awareness of any materials (e.g., radioactive material, bio-hazardous material, etc.) or other conditions that travel through or occur in a monitored area.

In some embodiments, the sensor data representation module 210 includes location functionality configured to show a sensor, alerts, and events geographically. The location functionality may be used to plot the various sensors at their respective location on a map within a graphical user interface (GUI). The GUI may allow for rich visual maps with detailed floor plans at various zoom levels, etc. The sensor data representation module 210 may send sensor data, alerts, and events to a messaging system (e.g., messaging system 108) for distribution (e.g., other users, safety officials, etc.).

Alerts from one or more sensors may be grouped, aggregated, represented, and/or indicated as an event. An event may thus be associated with one or more alerts from one or more sensors. The event may be determined based on one or more conditions, rules, parameters, or heuristics applied to one or more alerts. For example, a single alert could be a fluke or a blip in a sensor reading. When multiple alerts occur, however, there is a high likelihood that something more significant is taking place. For example, multiple alerts occurring within the same area or within a certain proximity of one another or facility may indicate that a hazardous material is present in that area. In another example, five alerts that happen within the preceding one minute within the same building and on the same floor may be aggregated into an event. The event may then be sent to an external system or highlighted on a graphical user interface.

In some embodiments, an operator may be able to mark an alert, or series of alerts, as an “event.” The sensor data representation module 210 may allow a user (e.g., operator, administrator, etc.) to group multiple sensors together, e.g., via a text block field, via a mouse selection, via a dropdown menu, etc., to create an event associated with multiple alerts from a group of selected sensors. For example, a code red event may be created when three sensors or more within twenty feet of one another and within the same physical space have a sensor reading that is at least 40% above historical values. In some embodiments, the sensor based detection system 102 may automatically group sensors together based on the geographical proximity of the sensors, e.g., the sensors of gates 1, 2, and 3 within terminal A at LAX airport may be grouped together due to their proximate location with respect to one another, e.g., physical proximity within the same physical space, whereas sensors in different terminals are not grouped because of their disparate locations. However, in certain circumstances sensors within the same airport may be grouped together in order to monitor events at the airport as a whole and not at more granular level of terminals, gates, etc. It is further appreciated that other criteria may be used to group sensors and events together, e.g., sensor types, sensor readings, sensor proximity relative to other sensors, sensor locations, common paths in a structure past sensors, etc.

Representation of sensors (e.g., icons, images, shapes, rows, cells, etc.) may be displayed on a map and be configured for selection to be associated with an event. For example, five alerts with respect to five associated sensors within a particular vicinity may be displayed and an operator may select (e.g., highlight, click on, etc.) the five sensors (e.g., via lasso selection, click and drag selection, click selection, etc.) to group the sensors as an event. Alerts from the five sensors may then be displayed or sent as an event. A condition may also be applied to the group of five sensors such that an event is triggered based on one or more of the sensors in the group of five sensors satisfying a condition (e.g., reaching particular radiation level, exceeding a range of radiation readings, etc.).

In some embodiments, the sensor data representation module 210 may automatically select sensors to be associated as an event. For example, sensors within a 10 meters radius of each other within the same building can automatically be grouped so that alerts from the sensors will be indicated as an event.

The sensor data representation module 210 may access or receive one or more conditions, parameters, or heuristics via a graphical user interface, as input by an operator for instance, that may be used to configure the sensor process manager 204/state change manager 208 in determining an event. The one or more conditions, parameters, or heuristics may be received via the graphical user interface of a sensor data representation module 210, a sensor process manager 204, state change manager 208. The sensor data representation module 210 may determine whether an event has occurred based on an evaluation (e.g., a comparison, an algorithm, etc.) of the analyzed sensor data, the sensor metadata, and the one or more conditions, parameters, or heuristics. For example, sensors on a particular floor of a building may be selected as an event based on the associated location metadata of the sensors.

In another example, the parameters, conditions, or heuristics may be when metadata of sensors has substantially similar values or is within a range of particular values and/or the sensors are associated within a particular temporal time spans (e.g., number of minutes or hours interval over which sensor data is analyzed). Exemplary parameters may include, but are not limited to, building name, floor level, room number, geospatial coordinates within a given range (e.g., distance between sensors, proximity of sensors, etc.), sensor vendors, sensor type, sensor properties, sensor configuration, etc.

The heuristics may include a geographical range (e.g., sensors within a 20-30 meter range, larger range, etc.) or may be based on the time of travel or distance between particular sensors, etc. For example, if it normally takes people 30 minutes to pass through a security checkpoint then if any sensor within the security checkpoint has an alert state for a one minute interval or for a 30 minute interval an event based on the heuristics may be reported. An elevated or alert sensor state of 30 minutes may correspond to a particularly high radiation level that may be worth further investigation.

The heuristics may further include a distance between the sensors and proximity of the sensors. That is, the heuristics may be based on the time, distance, and proximity of the sensors. For example, if two adjacent sensors are sufficiently distant from each other so that radioactive material does not set off both sensors and a person traveling past the sensors would take at least 10 minutes to walk past both sensors, when alerts are generated based on both sensors in a particular order within 10 minutes, an associated event is generated.

An event and associated parameters, conditions, etc., may be based on the geographic proximity of the sensors. An event may thus allow focusing a user's attention (e.g., operator, administrator, etc.) on particular sensor data for a particular area. Metadata associated with the sensors including location, etc., may be used for event determination. For example, a single sensor based alert may be caused by an abnormality, background radiation, etc., while alerts from three, five, or seven sensors within 10 meters of each other may be indicative of a dangerous condition (e.g., hazardous material, hazardous cloud, etc.) that should be further analyzed or further attention directed thereto.

Based on determining that an event has occurred, an indicator may be output by the sensor data representation module 210. In some embodiments, the indicator may be output visually, audibly, or via a signal to another system (e.g., messaging system 108).

In some embodiments, an event may be configured with a parameter specifying where an event indicator should be sent. For example, an event indicator may be displayed in the GUI or the event indicator may be sent to an external system (e.g., messaging system 108).

The indicator may be based on one or more alerts from one or more sensors or an event based on alerts from multiple sensors. The events may be based on groups of sensors selected manually (e.g., via a GUI, command line interface, etc.) or automatically (e.g., based on an automatic grouping determined by the sensor based detection system 102), or based on heuristics. In some embodiments, the indicator (e.g., alert, event, message, etc.) may be output to a messaging system (e.g., messaging system 108 or messaging module 214). For example, the indicator may be output to notify a person (e.g., operator, administrator, safety official, etc.) or group of persons (e.g., safety department, police department, fire department, homeland security, etc.).

The sensor data representation module 210 may have various tools to “replay” after an event has occurred. The sensor data representation module 210 may further allow an operator to configure the sensor data representation module 210 to send alerts to external entities. For example, the operator can configure an XML interface to forward alerts and events to a local Fusion Center (e.g., of the federal government, another government office, etc.). The operator may further configure an SMS gateway or even a Twitter™ account to send alerts or events to.

In some embodiments, one or more functionalities of a sensor based detection system (e.g., sensor based detection system 102) may be invoked upon determining that an event has occurred. For example, a message may be sent if an event has occurred, a determination of the path of travel of a hazardous material or condition may be determined if an event has occurred, video may be displayed associated with sensor readings if an event has occurred, an alarm may be signaled if an event has occurred, etc.

The notification module 215 is responsible for managing notification triggers. In some embodiments, a notification trigger specifies one or more conditions and one or more actions that are performed when the one or more conditions are satisfied. A condition specified for a notification trigger may be, in some embodiments, one or more rules, parameters, and/or heuristics (e.g., a sensor reading value, a range of sensor reading values, a threshold sensor reading value, etc.) that are applied to alert and/or event information. For instance, a notification trigger may specify conditions based on alerts (e.g., individual sensor alerts, several sensor alerts, etc.), conditions based on events, or any combination thereof.

In some embodiments, a notification trigger may specify several conditions that are each based on a different sensing modality. For example, a notification trigger may specify a condition (e.g., a decrease in water level) based on a sensing modality that senses water level, a condition (e.g., an increase in temperature) based on a sensing modality that senses temperature, and a condition (e.g., an increase in air pressure) based on a sensing modality that senses air pressure. In other words, in this example, the conditions of such a notification trigger are satisfied when one or more sensors sense (e.g., within a specified amount of time and/or in a specified sequence) the specified water level, temperature, and air pressure. This way, notification triggers allow actions (e.g., sending messages to third parties) to be performed based on multiple different sensor modalities. For instance, an action for a notification trigger may specify to send a message to a fire department when conditions for the notification trigger specify one or more sensors sense a decrease in water level, increase in temperature, and an increase in air pressure because the combination of sensed information indicates the presence of a fire. It is appreciated that additional and/or different conditions based on any number of different types of sensing modalities (e.g., fire sensing modality, radiation sensing modality, chemical sensing modality, biological sensing modality, pathogen sensing modality, etc.) may be specified for a notification trigger.

In some embodiments, an action specified for a notification trigger may be sending a message (e.g., sending a message in any of the manners described below by reference to the messaging module 220) to third parties. It is appreciated that a notification trigger may specify any number of different actions (e.g., sending messages to different third party entities, persons, systems, etc., or any combination thereof). In some embodiments, the notification module 215 instructs the messaging module 220 to perform the actions (e.g., sending messages) specified for a notification trigger.

The notification module 215 may be configured to create notification triggers. For instance, the notification module 215 may be configured to provide a graphical user interface for creating a notification trigger. Such a graphical user interface allows users to specify one or more conditions for a notification trigger and one or more actions for the notification trigger that are performed when the one or more conditions are satisfied. In some embodiments, the notification module provides conditions from which users may select for notification triggers that are preconfigured and/or generated from configuration files.

In addition, the notification module 215 may handle processing of notification triggers. For example, the notification module 215 may receive various information such as alert and/or event information from the data store 206, the state change manager 208, and the sensor data representation module 210 and apply and/or evaluate conditions (e.g., rules, parameters, and/or heuristics) specified for a notification trigger to determine whether the conditions are satisfied. In response to determining that conditions specified for a notification trigger are satisfied, the notification module 215 performs the actions specified for the notification trigger. In some embodiments, the notification module 215 instructs the messaging module 220 to perform the actions (e.g., formatting and sending messages to third parties) specified for the notification trigger. The notification module 215 may, in some embodiments, process notification triggers at defined intervals (e.g., once a minute, once an hour, once a day, etc.), when a state of a sensor changes (e.g., as determined by the state change manager 208 and/or the notification module 215), when a defined event occurs, or any combination thereof.

The notification module 215 may access, receive, etc. information from a data store 206, a state change manager 208, and/or a sensor data representation module 210. The data store 206 may receive and store alerts from a state change manager 208 and events from a sensor data representation module 210. In some embodiments, the data store 206 may include notification triggers that have been created (e.g., via a graphical user interface). The data store 206 may also include templates that are used for assembling a message (e.g., including formatting a message). The data store 206 may also include notification trigger templates for creating notification triggers (e.g., via a graphical user interface). In some embodiments, the notification module 215 receives alerts, events, metadata, templates, notification trigger templates, and notification triggers from the data store 206. The data store 206 may receive data (e.g., records, log entries, etc.) associated with messages sent by the messaging module 220. In some embodiments, the notification module 215 may receive alerts, events, and metadata from the state change manager 208 and/or the sensor data representation module 210.

Some embodiments allow for the creation of notification triggers that specify a first set of rules to be used for grouping alerts into events and a second set of rules to be used to determine whether to send a message or perform additional and/or other actions based on the events and/or alerts. For alerts, for example, the location, the time of the alert, or repeat intervals at which the alert happened may be used to determine whether to send a message based on the alert. For events, for example, the heuristics, as described above with respect to events, may be applied to determine whether to send a message based on the event. In some embodiments, an alert queue and an event queue of the notification module 215 are used to receive alerts and events upon which the rules, parameters, conditions, or heuristics, are applied to determine whether to send a message based on the alert or event. In some embodiments, a destination (e.g., messaging system, data store, etc.) may be selected based on rules, conditions, parameters, or heuristics. For example, NIEM may be the desired messaging format for a governmental agency as its destination to report a chemical, a biological, and/or a radiological event.

The messaging module 220 is configured to send messages to other systems or messaging services including, but not limited to, a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc. In one example, national information exchange model (NIEM) compliant messaging may be used to report chemical, biological, radiological and nuclear defense (CBRN) suspicious activity reports (SARs) to report to government entities (e.g., local, state, or federal government). It is appreciated that the messages may be formatted to comply with the requirement/standards of the messaging service used. For example, as described above a message may be formed into the NIEM format in order to report a CBRN event.

In some embodiments, the messaging module 220 (e.g., in conjunction with sensor data representation module 210) may be configured to send alerts and/or events to external end-points (e.g., messaging services or systems, governmental entities, databases, etc.). For example, an operator could configure an XML interface to forward all alerts to a local Fusion Center. In another example, the operator can configure an SMS gateway or even a Twitter™ account to receive messages (e.g., including alerts and/or events).

In some embodiments, alerts or events may be escalated (e.g., by a user, operator, administrator, etc.) via the messaging module 220 to appropriate authorities (e.g., local, state, or federal government). It is appreciated that the alerts or events may be further escalated automatically and based on heuristics. It is appreciated that the alerts or events may further be escalated, for example, by sending additional messages to the same responsible party, the responsible party's respective superior, or a different entity if the original messages that were transmitted are not processed or responded to in a timely fashion.

The messaging module 220 may be configured to act as an interface to third parties and third party systems and format a message accordingly. The messaging module 220 may support a variety of formats and may further support adding additional formats. In some embodiments, the messaging module 220 supports use of templates for message formatting. For example, an XML message may be formatted using one or more templates including variables or metadata keys. The metadata keys may be placeholders or variables for sensor metadata within the message and used for inserting sensor metadata associated with the alert or event prior to sending the message. For example, an XML message template may include “Warning: Sensor: <xsl:value-of select=“sensor-name”/> located at <xsl:value-of select=“sensor-location”/> has a reading of <xsl:value-of select=“sensor-reading”/>.” In some embodiments, the messaging module 220 may be configured to display a graphical user interface for creating a message template.

A message may further be sent via a telephone call (e.g., to a mobile device) or to a pager. For example, text to speech may be used to communicate the message via a telephone call. A message may also be communicated to a controller board (e.g., dry contact controller board) or another electronic system (e.g., lighting system, alarm system, or emergency evacuation system).

In some embodiments, radiation sensor based data (e.g., alerts and events) or other sensor based data is evaluated to determine whether a message is to be sent. For example, if radiation sensor based data indicates that a dosage of radiation above a particular mSv level has been detected, a message may be sent based on the alert associated with the radiation dosage in a NIEM format to a Fusion Center.

Embodiments are thus configured to send messages based on sensor based detection of a variety of materials, conditions, etc. For example, messages may be sent based on detection of biological, chemical, or radioactive, etc. threats. As another example, a message may be sent based on the detection of certain levels of radiation or bio-hazardous material or levels of radiation (e.g., greater than 1 Sv) or bio-hazardous material that varies outside of a specified limit or range (e.g., 300 mSV-900 mSv).

FIG. 2 illustrates the notification module 215 and the messaging module 220 as separate modules. It is appreciated that the notification module 215 and the messaging module 220 may be implemented as a single module. For example, in some embodiments, the notification module 215 may be implemented as part of the messaging module 220.

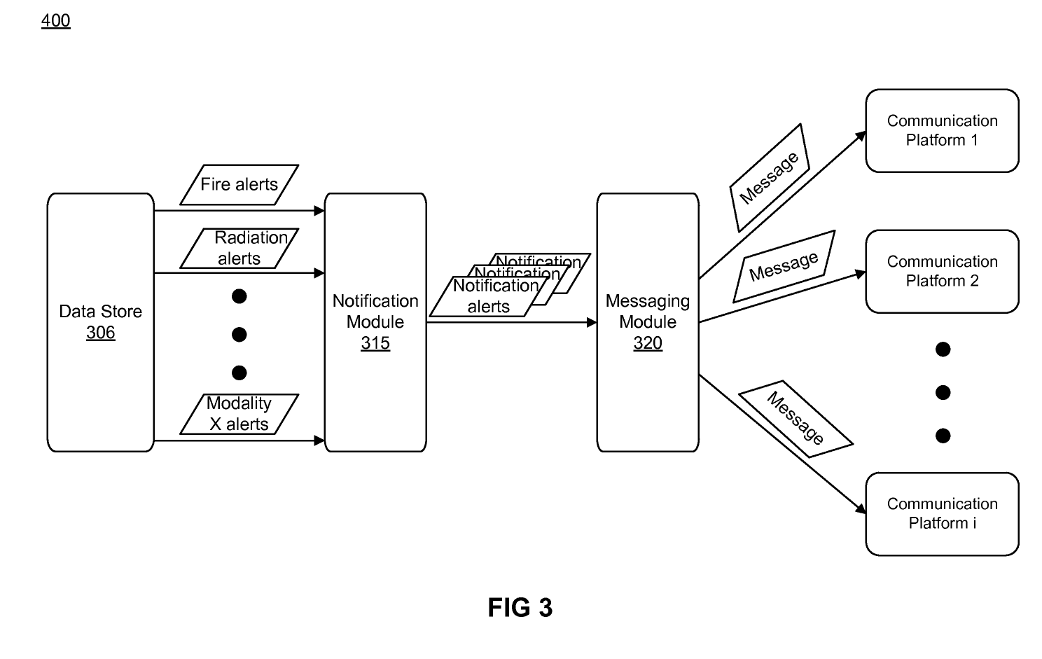

FIG. 3 shows a block diagram of notification alert dataflow in accordance with some embodiments. As shown, FIG. 3 illustrates a data store 306, a notification module 315, a messaging module 320, and communication platforms 1-k. The data store 306, the notification module 315, and the messaging module 320 may be the same or similar to the data store 206, the notification module 215, and the messaging module 220, respectively. In some embodiments, the notification module 315 and the messaging module 320 may execute on one or more computing systems (e.g., virtual or physical computing systems). The notification module 315 may be part of a sensor data representation module, such as the sensor data representation modules described in U.S. patent application Ser. No. 14/315,289, filed Jun. 25, 2014.

The data store 306 may include sensor data, analyzed sensor data, and sensor metadata (e.g., including a sensor's name, description, location, longitude, latitude, building, floor, campus, description, manufacturer, etc.). In some embodiments, the data store 306 may be a data warehouse. In some embodiments, the data store 306 may include a state change manager (not shown), which may be configured to determine whether a state of a sensor has changed and to generate an alert based on the state change of a sensor.

In some embodiments, the data store 306 is configured to function as an alert service configured to provide (e.g., to the notification module 315) the current alert status for each sensor time path or time interval, real time alert status changes for sensor time paths, and event reporting. The notification module 315 may receive the current alert status for each sensor time path and events from the data store 306. In some embodiments, events are queued up and retained in a data store (e.g., data store 306) until consumed by the notification module 315. In some embodiments, events are retained (e.g., archived for later processing and/or retrieval) in the data store upon consumption by the notification module 315 while, in other embodiments, events are deleted from the data store upon consumption by the notification module 315.

The notification module 315 is configured to receive alerts, events, and/or notification triggers from the data store 306. As shown in FIG. 3, the notification module 315 receives several different sensor modality alerts. Specifically, the notification module receives fire alerts, radiation alerts, and modality x alerts where modality x alerts may be any number of different sensor modality alerts. In some embodiments, the notification module 315 may further determine events based on criteria (e.g., including rules, conditions, parameters, and heuristics) of one or more of the same and/or different sensor modality alerts. The notification module 315 may store (e.g., in an alert and event log) the events and alerts (e.g., one or more of the same and/or different sensor modality alerts) and send the events and alerts to the data store 306 for storage.

In some embodiments, the notification module 315 may process notification triggers by evaluating the conditions (e.g., based on several different sensor modality alerts) specified for the notification triggers and performing the actions specified for notification triggers with conditions that the notification module 315 determines are satisfied. In this example, the actions specified for notification triggers are sending notification alerts to third parties via communication platforms 1-k. As illustrated in FIG. 3, the notification module 315 sends notification alerts to the messaging module 320. The messaging module 320, in turn, sends messages (e.g., in the same or similar manner as messaging module 220) to third parties via any number of different communication platforms 1-k. In some embodiments, the messaging module 320 may format a message (e.g., based on a template) based to the communication platform(s) (e.g., communication platforms 1-k) through which the messaging module 320 sends the message. In some embodiments, the messaging module 320 may be part of or embedded in the notification module 315. In some embodiments, messaging module 320 may be a stand alone application.

Communication platforms 1-k are platforms for delivering communications to third parties (e.g., personnel, government entities, systems, etc.). In some embodiments, communication platforms 1-k may each include a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc.

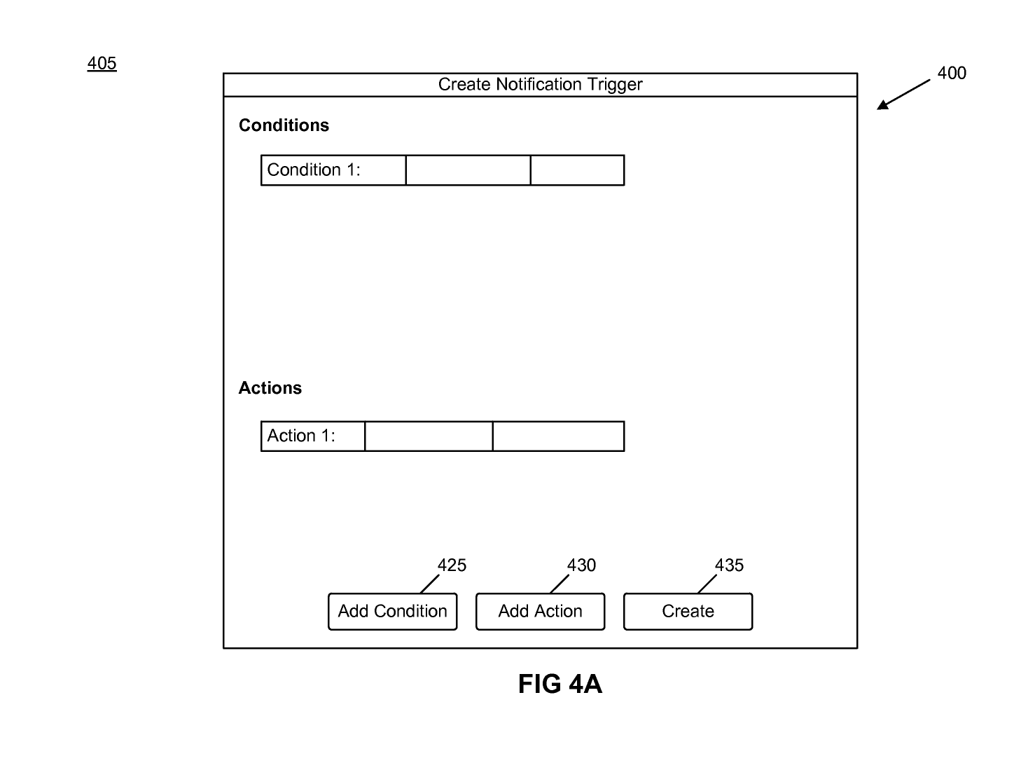

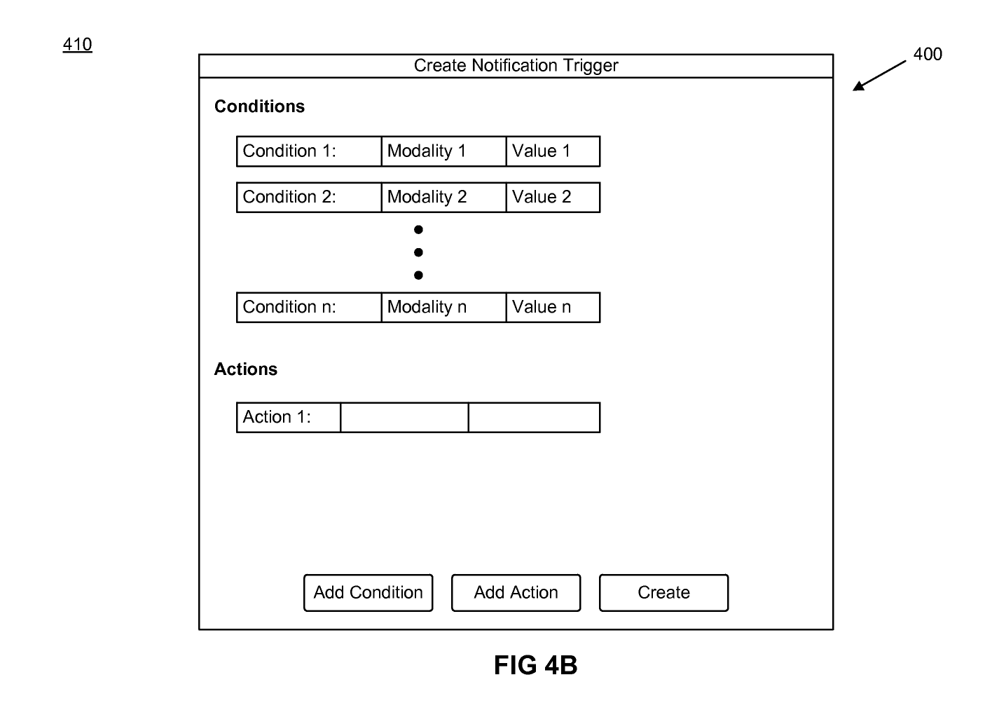

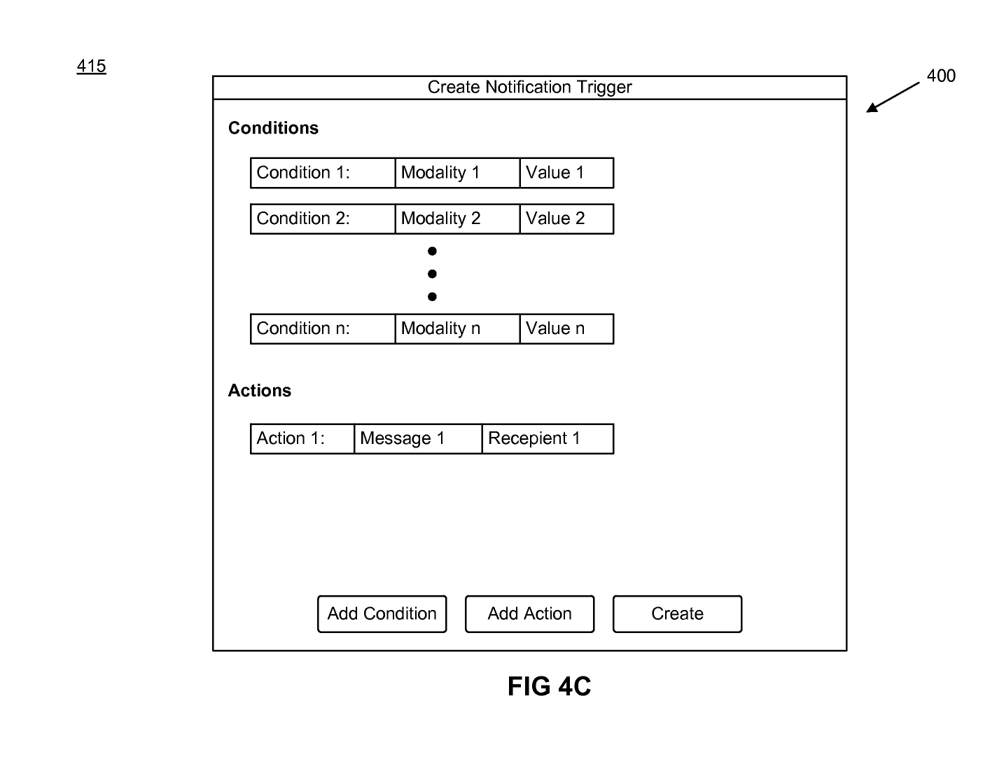

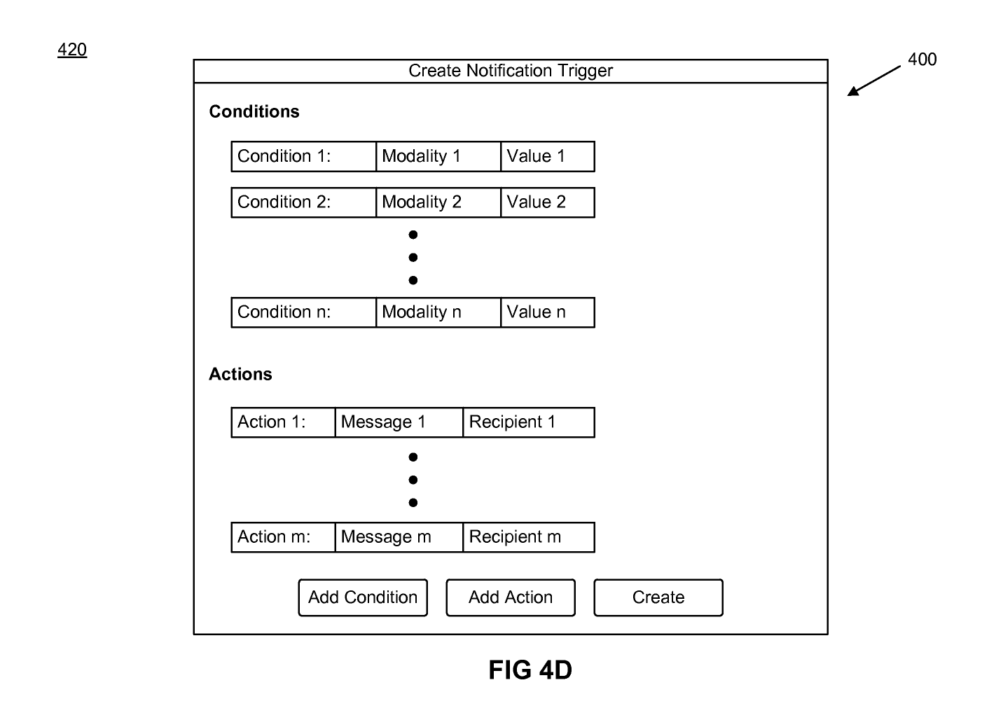

FIGS. 4A-4D show a graphical user interface (GUI) 400 for creating notification triggers in accordance with some embodiments. In particular, FIGS. 4A-4D illustrate the GUI 400 at four stages 405, 410, 415, and 420 of creating a notification trigger. As shown, the GUI 400 includes user-selectable items 425, 430, and 435. User-selectable item 425 is for adding a condition to the notification trigger, user-selectable item 430 is for adding an action to the notification trigger, and user-selectable item 435 is for creating and storing (e.g., in the data store 306) the notification trigger.

The first stage 405 shows of the GUI 400 without any conditions nor actions specified for a notification trigger. In some embodiments, the first stage 405 is displayed when a user selects an option (e.g., a user-selectable item) to create a notification trigger that is displayed on a different GUI (not shown).

The second stage 410 illustrates the GUI 400 after the user has added n conditions to a notification trigger. In some embodiments, the user may specify a sensing modality (e.g., a temperature sensing modality, an air pressure sensing modality, a motion sensing modality, a radiation sensing modality, etc.) and a value for a condition (e.g., Condition 1) via a textbox, drop down menu, pop-up menu, a list box, etc. It is appreciated that the user may specify any number of different types of values (e.g., a sensor reading value, a range of sensor reading values, a threshold sensor reading value, etc.) as the value for a condition. The user may add conditions for the notification trigger by selecting user-selectable item 425, and subsequently specify a sensing modality and a value for the added condition.

The third stage 415 shows the GUI 400 after the user has specified a message and recipient for an action (e.g., Action 1) of the notification trigger. In some embodiments, may specify the message and recipient via a textbox, drop down menu, pop-up menu, a list box, etc. It is appreciated that the user may specify one or more recipients for an action.

The fourth stage 420 illustrates the GUI after the user has added m actions to the notification trigger. The user may specify a message and recipient for the added actions (e.g., Actions 2-m) in the same or similar manner as that describe for the third stage 415.

FIG. 4 illustrates an example GUI for creating a notification trigger. It is appreciated that the GUI for creating a notification trigger may have additional and/or different elements and may be arranged in any number of different ways.

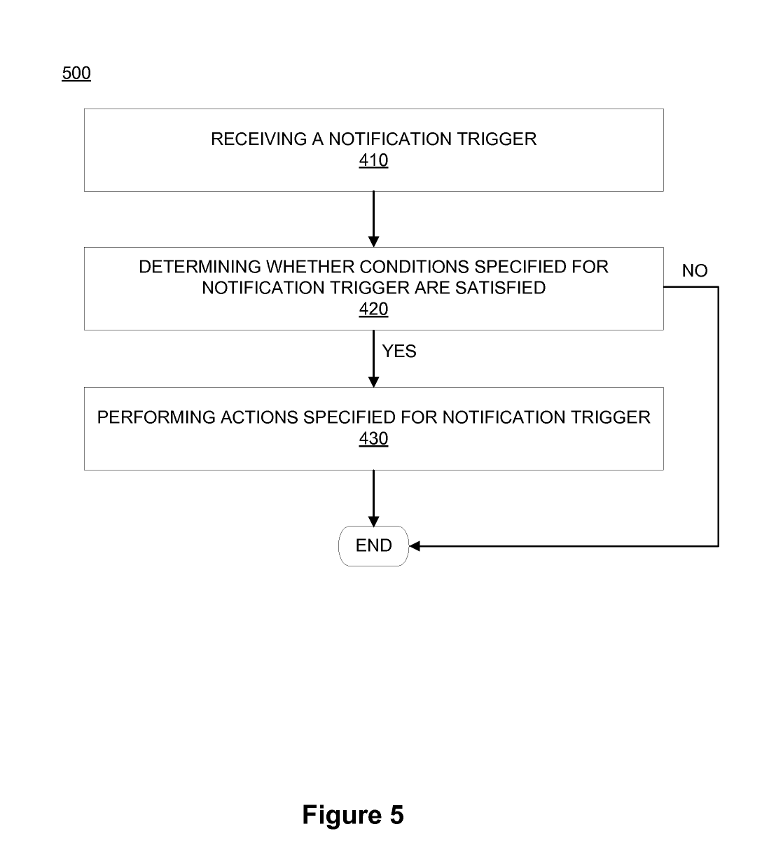

FIG. 5 shows a flow diagram for processing a notification trigger in accordance with some embodiments. In some embodiments, a notification module (e.g., notification module 215 or notification module 315) performs the operations described in FIG. 5 (e.g., at specified intervals (e.g., once a minute, once an hour, once a day, etc.), in response to receiving a new alert, etc.) for each created notification trigger (e.g., notification triggers stored in the data store 306).

At 510, the notification module receives a notification trigger. In some embodiments, the notification module receives the notification trigger from a data store. Referring to FIG. 3 as an example, the notification module 315 may receive the notification trigger from the data store 306. As mentioned above, a notification trigger may specify several conditions that are each based on a different sensing modality in some embodiments. At 520, the notification module determines whether conditions specified for the notification trigger are satisfied. In some embodiments, the notification module evaluates the conditions (e.g., rules, parameters, and/or heuristics) specified for the notification trigger to determine whether the conditions are satisfied.

When the notification module determines that the conditions specified for the notification trigger are satisfied, the notification module performs, at 530, the actions specified for the notification trigger. As mentioned above, an action specified for a notification trigger may be sending a message (e.g., sending a message in any of the manners described below by reference to the messaging module 220) to third parties, in some embodiments and a notification trigger may specify any number of different actions (e.g., sending messages to different third party entities, persons, systems, etc., or any combination thereof). When the notification module determines that the conditions specified for the notification trigger are not satisfied, the notification module may continue processing any remaining notification triggers by performing operations 510, 520, and 530 on the remaining notification triggers.

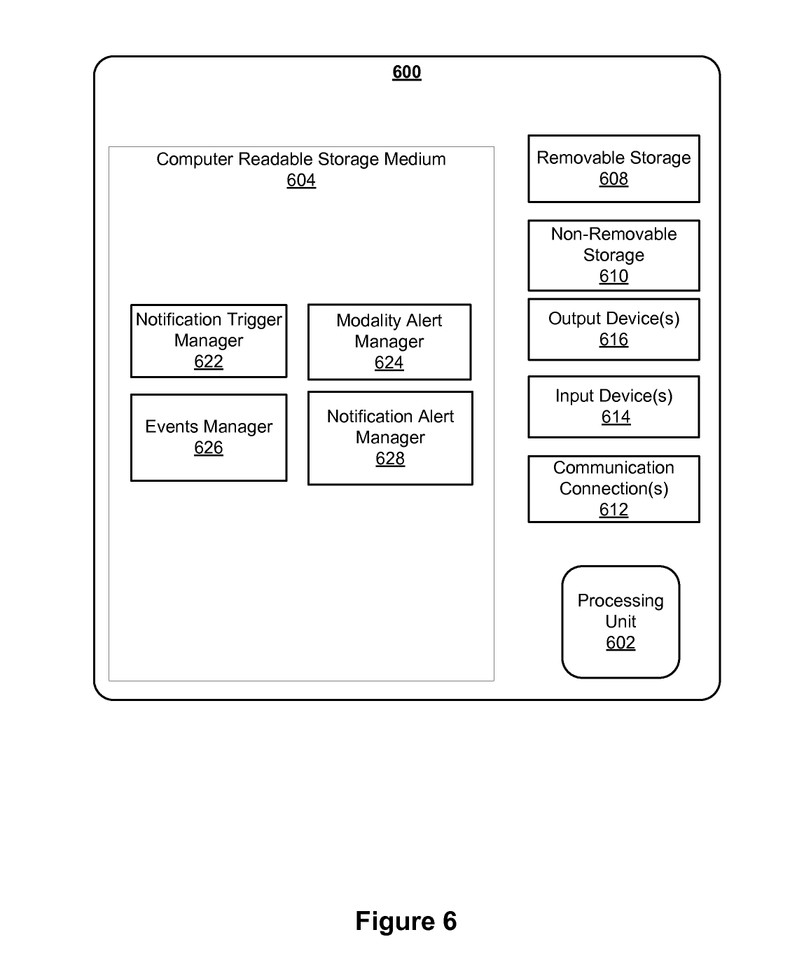

Referring now to FIG. 6, a block diagram of a computer system in accordance with some embodiments is shown. With reference to FIG. 6, a system module for implementing embodiments includes a general purpose computing system environment, such as computing system environment 600. Computing system environment 600 may include, but is not limited to, servers, switches, routers, desktop computers, laptops, tablets, mobile devices, and smartphones. In its most basic configuration, computing system environment 600 typically includes at least one processing unit 602 and machine readable storage medium 604. Depending on the exact configuration and type of computing system environment, machine readable storage medium 604 may be volatile (such as RAM), non-volatile (such as ROM, flash memory, etc.) or some combination of the two. Portions of machine readable storage medium 604 when executed may communicate alerts to third parties based on different sensor modality alerts (e.g., process 500).

Additionally, in various embodiments, computing system environment 600 may also have other features/functionality. For example, computing system environment 600 may also include additional storage (removable and/or non-removable) including, but not limited to, magnetic or optical disks or tape. Such additional storage is illustrated by removable storage 608 and non-removable storage 610. Computer storage media includes volatile and nonvolatile, removable and non-removable media implemented in any method or technology for storage of information such as machine readable instructions, data structures, program modules or other data. Machine readable medium 604, removable storage 608 and nonremovable storage 610 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 600. Any such computer storage media may be part of computing system environment 600.

In some embodiments, computing system environment 600 may also contain communications connection(s) 612 that allow it to communicate with other devices. Communications connection(s) 612 is an example of communication media. Communication media typically embodies machine readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term machine readable media as used herein includes both storage media and communication media.

Communications connection(s) 612 may allow computing system environment 600 to communicate over various networks types including, but not limited to, fibre channel, small computer system interface (SCSI), Bluetooth, Zigbee, Z-Wave, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 612 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 600 may also have input device(s) 614 such as keyboard, mouse, a terminal or terminal emulator (either connected or remotely accessible via telnet, SSH, http, SSL, etc.), pen, voice input device, touch input device, remote control, etc. Output device(s) 616 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length. In some embodiments, machine readable storage medium 604 includes a notification trigger manager module 622, a modality alert manager module 624, an events manager module 626, and a notification alert manager module 628. The notification trigger manager module 622 is operable to process notification triggers according to flow diagram 500, for instance. The modality alert manager module 624 may be used to receive and manage different sensor modality alerts. The events manager module 626 operates to determine events based on the same and/or different sensor modality alerts and/or events. The notification alert manager module 628 is responsible for sending notification alerts to a messaging module (e.g., the messaging module 320), which forwards the notification alerts to third parties.

It is appreciated that implementations according to some embodiments that are described with respect to a computer system are merely exemplary and not intended to limit the scope of the embodiments. For example, some embodiments may be implemented on devices such as switches and routers, which may contain application specific integrated circuits (ASICs), field programmable gate arrays (FPGAs), etc. It is appreciated that these devices may include a machine readable medium for storing instructions for implementing methods according to flow diagram 600.

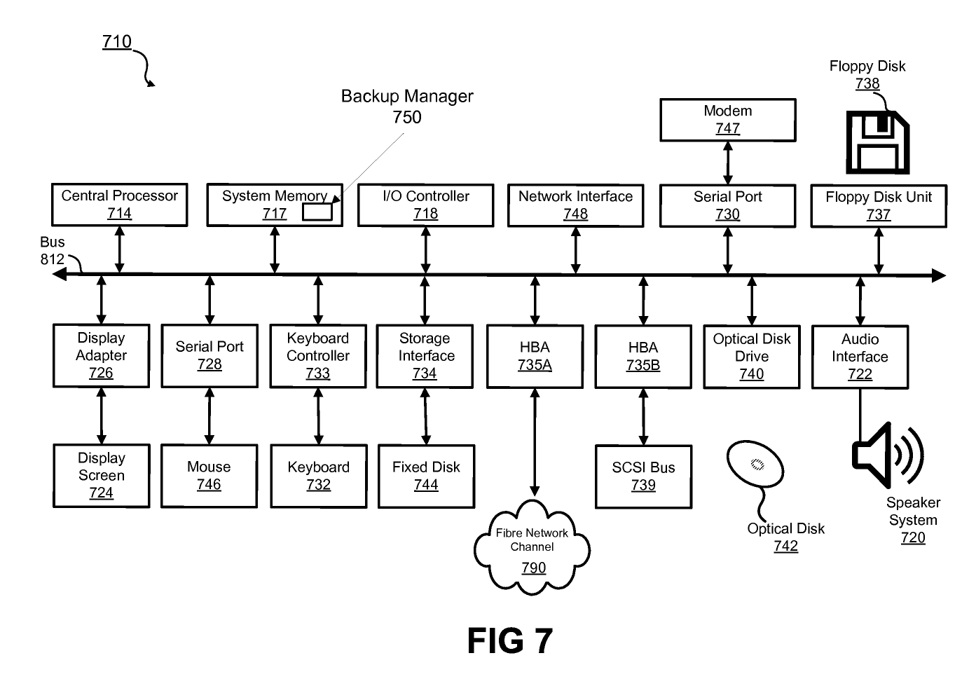

Referring now to FIG. 7, a block diagram of another computer system in accordance with some embodiments is shown. FIG. 7 depicts a block diagram of a computer system 710 suitable for implementing the present disclosure. Computer system 710 includes a bus 712 which interconnects major subsystems of computer system 710, such as a central processor 714, a system memory 717 (typically RAM, but which may also include ROM, flash RAM, or the like), an input/output controller 718, an external audio device, such as a speaker system 720 via an audio output interface 722, an external device, such as a display screen 724 via display adapter 726, serial ports 728 and 730, a keyboard 732 (interfaced with a keyboard controller 733), a storage interface 734, a floppy disk drive 737 operative to receive a floppy disk 738, a host bus adapter (HBA) interface card 735A operative to connect with a Fibre Channel network 790, a host bus adapter (HBA) interface card 735B operative to connect to a SCSI bus 739, and an optical disk drive 740 operative to receive an optical disk 742. Also included are a mouse 746 (or other point-and-click device, coupled to bus 712 via serial port 728), a modem 747 (coupled to bus 712 via serial port 730), and a network interface 748 (coupled directly to bus 712). It is appreciated that the network interface 748 may include one or more Ethernet ports, wireless local area network (WLAN) interfaces, Bluetooth interfaces, Zigbee interfaces, Z-Wave interfaces, etc., but are not limited thereto. System memory 717 includes a notification module 750 which is operable to manage notification triggers (e.g., creating notification triggers, processing notification triggers, etc.). In. According to some embodiments, the notification module 750 may include other modules for carrying out various tasks. For example, the notification module 750 may include the notification trigger manager module 622, the modality alert manager module 624, the events manager module 626, and the notification alert manager module 628, as discussed with respect to FIG. 6 above. It is appreciated that the notification module 750 may be located anywhere in the system and is not limited to the system memory 717. As such, residing of the notification module 750 within the system memory 717 is merely exemplary and not intended to limit the scope of the embodiments. For example, parts of the notification module 750 may reside within the central processor 714 and/or the network interface 748 but are not limited thereto.

Bus 712 allows data communication between central processor 714 and system memory 717, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 710 are generally stored on and accessed via a machine readable medium, such as a hard disk drive (e.g., fixed disk 744), an optical drive (e.g., optical drive 740), a floppy disk unit 737, or other storage medium. Additionally, applications can be in the form of electronic signals modulated in accordance with the application and data communication technology when accessed via network modem 747 or interface 748.

Storage interface 734, as with the other storage interfaces of computer system 710, can connect to a standard machine readable medium for storage and/or retrieval of information, such as a fixed disk drive 744. Fixed disk drive 744 may be a part of computer system 710 or may be separate and accessed through other interface systems. Network interface 748 may provide multiple connections to other devices. Furthermore, modem 747 may provide a direct connection to a remote server via a telephone link or to the Internet via an internet service provider (ISP). Network interface 748 may provide one or more connection to a data network, which may include any number of networked devices. It is appreciated that the connections via the network interface 748 may be via a direct connection to a remote server via a direct network link to the Internet via a POP (point of presence). Network interface 748 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 7 need not be present to practice the present disclosure. The devices and subsystems can be interconnected in different ways from that shown in FIG. 7. The operation of a computer system such as that shown in FIG. 7 is readily known in the art and is not discussed in detail in this application. Code to implement the present disclosure can be stored in machine-readable storage media such as one or more of system memory 717, fixed disk 744, optical disk 742, or floppy disk 738. The operating system provided on computer system 710 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments disclosed. Many modifications and variations are possible in view of the above teachings.

What is claimed is:

1. A system comprising:
an alert module configured to receive a plurality of different sensor modality alerts;
an event module configured to determine events based on the plurality of different sensor modality alerts;
a notification trigger module configured to determine whether to cause transmission of notification alerts based on the determined events; and
a notification alert module configured to communicate notification alerts to a plurality of third parties based on the determination by the notification trigger module.

2. The system as described in claim 1 further comprising a messaging module configured to receive the notification alerts from the notification alert module.

3. The system as described in claim 2, wherein the messaging module is further configured to send messages to the plurality of third parties via a plurality of different communication platforms based on the notification alerts.

4. The system as described in claim 1, wherein the notification trigger module is further configured to determine whether to cause transmission of notification alerts further based on at least one alert in the plurality of different sensor modality alerts.

5. The system as described in claim 1, wherein the notification trigger module determines whether to cause transmission of notification alerts by determining whether conditions specified for the notification trigger are satisfied.

6. The system as described in claim 5, wherein the notification alert module is further configured to communicate notification alerts for the notification trigger when the notification trigger module determines that the conditions specified for the notification trigger are satisfied.

7. The system as described in claim 1 further comprising a data store module configured to receive data associated with a sensor having a plurality of different sensing modalities.

8. The system as described in claim 7, wherein the data store module is further configured to determine whether a state of a sensing modality in the plurality of different sensing modalities of the sensor has changed and to generate a sensor modality alert based on the state change of the sensing modality.

9. A system comprising:
a sensor with a plurality of modalities, wherein the sensor is configured to measure information associated with a plurality of data types, wherein each data type is associated with a modality of the plurality of modalities, wherein the sensor is further configured to generate a plurality of modality measurements; and
a notification module configured to process the plurality of modality measurements and to determine whether a set of conditions are satisfied,
wherein the notification module is further configured to perform a set of actions in response to determining that the conditions are satisfied.

10. The system as described in claim 9, wherein the set of actions comprises sending a message to a set of third parties regarding the plurality of modality measurements.

11. The system as described in claim 9, wherein the notification module is further configured to determine an event based on the plurality of modality measurements.

12. The system as described in claim 11, wherein the set of conditions is based on the determined event.

13. The system as described in claim 9 further comprising a data store configured to receive the plurality of modality measurements.

14. The system as described in claim 13, wherein the data store is further configured to generate a plurality of sensor alerts based on the plurality of modality measurements.

15. The system as described in claim 9, wherein the plurality of modalities includes a radiation modality.

16. A system comprising:
a sensor configured to measure information associated with a first data type and a second data type, wherein the first data type is associated with a first modality and the second data type is associated with a second modality, wherein the sensor is further configured to generate a plurality of modality measurements; and
a set of computing devices configured to process the plurality of measurements and to determine whether a set of conditions are satisfied,
wherein the set of computing devices is further configured to send messages to a plurality of third parties in response to determining that the set of conditions are satisfied.

17. The system as described in claim 16, wherein the sensor is further configured to measure information associated with a third data type, wherein the third data type is associated with a third modality.

18. The system as described in claim 16 further comprising a data store configured to receive the plurality of modality measurements.

19. The system as described in claim 16, wherein the set of computing devices is further configured to provide a graphical user interface for specifying the set of conditions.

20. The system as described in claim 19, wherein the set of conditions are specified through the graphical user interface based on a template.
